(19) United States
(12) Patent Application Publication
(10) Pub. No.: US 2023/0045430 A1
(43) Pub. Date: Feb. 9, 2023

(54) INEFFICIENT ELECTRIC MOTOR OPERATION DURING CHARGE LIMITING VEHICLE OPERATION

(71) Applicant: Ford Global Technologies, LLC, Dearborn, MI (US)

(72) Inventors: Shunsuke Okubo, Belleville, MI (US); Brendan F. Diamond, Grosse Pointe, MI (US); Alan Robert Dona, Huntington Woods, MI (US)

(21) Appl. No.: 17/392,900

(22) Filed: Aug. 3, 2021

(51) Int. Cl. B60L 7/16; B60L 58/13

(52) U.S. Cl. CPC B60L 7/16; B60L 58/13; B60L 2210/30; B60L 2240/36; B60L 2240/54; B60L 2240/423; B60L 2240/425

(57) ABSTRACT

A drivetrain includes an electric machine, an inverter, and a controller. The controller, for a given operating point of the electric machine, may schedule a method of commutation for switches of the inverter during presence of a negative wheel torque request according to a charge rate corresponding to the negative wheel torque request, temperatures of the electric machine and/or inverter, and/or a battery state of charge.

### TECHNICAL FIELD

This disclosure relates to the control of automotive electrified powertrains.

### BACKGROUND

An alternatively powered vehicle may include a traction battery arranged to provide power to an electric machine. The electric machine may transform electrical energy from the traction battery to mechanical energy to move wheels of the vehicle. The electric machine may also transform mechanical energy from the wheels to electrical energy for storge in the traction battery.

### SUMMARY

An automotive vehicle includes an energy storage arrangement, an electric machine, an inverter electrically between the energy storage arrangement and electric machine, and a controller. The controller, for a given operating point of the electric machine, and responsive to a negative wheel torque request that corresponds to a charging rate of the energy storage arrangement that exceeds a rate threshold, operates switches of the inverter according to a first method of commutation. The controller further, for the given operating point, and responsive to a negative wheel torque request that corresponds to a charging rate of the energy storage arrangement that does not exceed the rate threshold, operates the switches according to a second method of commutation.

A method includes, for a given operating point of an electric machine, and a traction battery state of charge being greater than a state of charge threshold, operating switches of the inverter according to a first method of commutation responsive to a negative wheel torque request. The method also includes, for the given operating point, and the traction battery state of charge being less than the state of charge threshold, operating the switches according to a second method of commutation responsive to the negative wheel torque request.

A drivetrain includes an electric machine, an inverter, and a controller. The controller, for a given operating point of the electric machine and a negative wheel torque request while a temperature of the electric machine or inverter is less than a temperature threshold, operates the inverter to inject direct axis current into the electric machine. The controller further, for the given operating point and the negative wheel torque request, and the temperature exceeding the temperature threshold, operates the inverter to increase the direct axis current injected into the electric machine.

### BRIEF DESCRIPTION OF THE DRAWINGS

FIG. 1 is a schematic diagram of a vehicle.

FIG. 2 is a flow chart of an algorithm for controlling an electrified powertrain.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

In electrified vehicles, including both hybrid and battery electric vehicles, regenerative braking is used to slow down the vehicle and turn the vehicle's kinetic energy into electrical energy to charge the high voltage battery. Regenerative braking is accomplished through a coupling between the wheel and an electric motor on a driven axle. By rotating the rotor of the electrical motor (usually an interior permanent magnet motor), via the wheel coupling, a rotating magnet field is created through the magnetic field created by the permanent magnets. Due to this rotating magnetic field in the presence of coils, current is generated, travels along the coils, and is transferred to the energy storage arrangement (e.g., high voltage battery, super capacitor, etc.) via the electrical distribution system and insulated gate bipolar transistors as part of the inverter. The charging associated with regenerative braking has power limitations based on high voltage battery temperature, high voltage battery state of charge, temperature of various components (e.g., electric motor, inverter), etc.. During regenerative braking, if the high voltage battery is full (state of charge above a threshold level) or the requested charge rate is beyond the capability of the high voltage battery, friction brakes are used to slow down the vehicle and/or other components are powered (e.g., electric air conditioner, positive temperature coefficient heater, etc.) to reduce the amount of charge supplied to the high voltage battery. This information is often documented in feature functional description documents for such vehicles. Additionally, for plug in hybrid electric vehicles, when the state of charge is full (high) in some situations, compression braking enabled by an engine pull up is performed, which is undesirable due to associated noise, vibration, and harshness (NVH) and the potential surprise of the engine revving up when the vehicle is trying to slow down.

Determining the appropriate operating mode and calibration for a motor to operate in a most efficient manner is completed in the DQ domain where a torque control strategy utilizing Id and Iq current are used to control motor torque through directly measuring current and rotor angle as known in the art. Part of this calibration involves creating a typical maximum torque per ampere (MTPA) curve, which is an indication of the most efficient manner in which the electric motor operates based on a given current to produce maximum torque or vice versa. MTPA control, also known as unit current output maximum torque control, is a strategy that finds the current operating point that can output the maximum torque under constant stator current amplitude.

To convert the high voltage battery current from DC to AC and the regenerative braking current from AC to DC to charge the high voltage battery, a three-phase inverter can be used which uses six insulated gate bipolar transistors that switch on and off at a frequency up to 10 kHz. The technique of pulse width modulation (PWM) converts the existing current signal into the desired current signal. In addition, different types of pulse width modulation are used depending on what functionality and/or attributes to optimize, such as efficiency and NVH performance. PWM type is typically scheduled based on operating point of the electric motor (motor speed and torque output). That is, the operating point of the electric motor conventionally dictates which PWM type should be used. As an example, six step PWM would be used whenever a speed of 8,000 revolutions per minute (rpm) and 30 newton meters of torque is required, while sinusoidal PWM (SPWM) would be used whenever a speed of 9,000 rpm and 50 newton meters of torque is required. SPWM and state vector PWM (SVPWM) have the highest switching losses. Other PWM schemes (e.g., discontinuous PWM, etc.), however, are also contemplated. The higher the switching speed, the higher the associated electrical losses due to higher insulated gate bipolar transistor switching losses.

A solution to this problem is to operate the motor and control system in an inefficient manner, on purpose, to dissipate energy through the internal short circuit and/or electric motor, and to reduce the associated charge rate being used to charge the energy storage arrangement during regenerative braking. This can be implemented by operating the electric motor far away from the MTPA curve by creating a separate high loss look up table calibration. The high loss look up table can involve, for example, injecting additional direct axis current to dissipate energy and other inefficient current controls.

Clarke and Park transforms are commonly used in field-oriented control of three-phase AC machines. The Clarke transform converts the time domain components of a three-phase system (in abc frame) to two components in an orthogonal stationary frame (αβ). The Park transform converts the two components in the αβ frame to an orthogonal rotating reference frame (DQ). Implementing these two transforms in a consecutive manner simplifies computations by converting AC current and voltage waveforms into DC signals. By changing the phase and magnitude of the current through these types of transformations, the motor would be able to produce the same amount of torque while also generating more waste heat by operating away from the MTPA curve predefined (from eDrive mapping dynamometer testing) highest efficiency lines. In this particular example, based on the amount of waste heat desired to be generated, additional direct axis current could be commanded to be injected into the electric machine from the inverter while still commanding the same desired torque (high loss mode), where the additional direct axis current would be commanded to specifically generate heat.

The PWM strategy can also or alternatively be changed to use an inefficient PWM method and/or raise the switching speed of the inverter switches to increase switching losses such as switching from six step PWM to SVPWM and increasing the switching frequency from 5 kHz to 10 kHz. That is for a given operating point of the electric motor, the method of switching commutation can be changed based on various factors, such as charge rate associated with a negative torque request relative to a corresponding threshold, temperature of the inverter and/or electric motor relative to respective thresholds, and/or state of charge of the traction battery relative to a corresponding threshold. As a result, the method of switching commutation can be changed for a given operating point responsive to a temperature of the inverter and/or electric motor exceeding respective thresholds. Likewise, the method of switching commutation can be changed for a given operating point responsive to a state of charge of the traction battery exceeding a threshold, etc.

The charge rate could need reduction due to battery state of charge, thermal limitations (temperature), current limits, or an aggressive negative torque request resulting from a regenerative braking event, a grade assist event, or an attempt to hold vehicle speed steady while travelling downhill. Existing thermal measurement devices can be utilized to ensure the internal short circuit and electric motor do not become too hot during this operation. This can be used in conjunction with existing energy dissipation strategies like running the electric air conditioner or positive temperature coefficient heater at full capability to reduce charging rate.

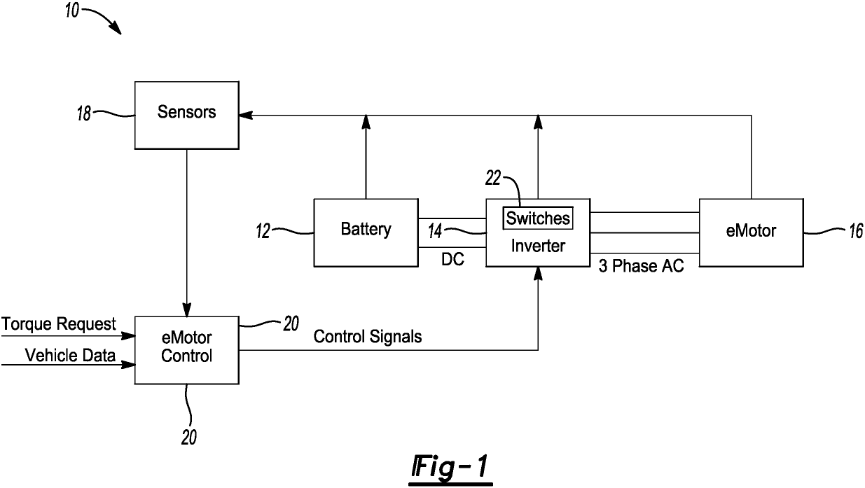

Referring to FIG. 1, an automotive vehicle 10 includes a traction battery 12, an inverter 14, an electric motor 16, sensors 18, and controller(s) 20. The inverter 14 includes a plurality of switches 22 arranged in usual fashion, and is electrically connected between the traction battery 12 and electric motor 16. Operation of the switches 22 can transform DC power from the traction battery 12 to three phase AC power for the electric machine 16, which can be used to drive wheels of the vehicle 10. Operation of the switches 22 can also transform three phase AC power from the electric machine 16 to DC power for storage in the traction battery 12. The sensors 18 (e.g., current sensors, temperature sensors, voltage sensors, etc.) are arranged to sense various data associated with the traction battery 12, inverter 14, and electric motor 16, and to report the same to the controller(s) 20. This data can include current, temperature, and voltage values of each of the previously mentioned (and other) components. The controller(s) 20, on the basis of the data from the sensors 18, incoming torque requests, and possibly other vehicle data, generate current and/or switching commands (e.g., SPWM, SVPWM, etc.) for the switches 22.

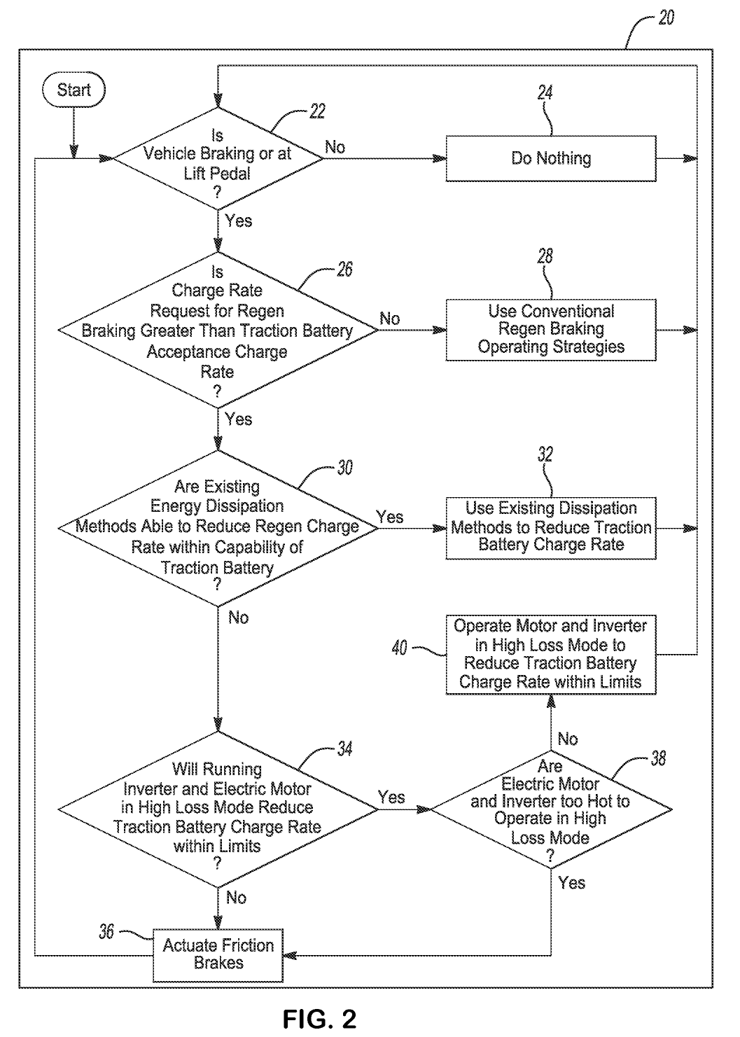

Referring to FIG. 2, at operation 22, the controller(s) 20 determine whether the vehicle 10 is braking or at lift pedal. Negative torque requests or brake system signals as known in the art may indicate that a driver has removed their foot from the accelerator pedal and/or placed their foot on the brake pedal. If no, the controller(s) 20 take no action at operation 24 and the algorithm returns to operation 22.

If yes, at operation 26, the controller(s) 22 determine whether the charge rate request for regenerative braking is greater than the traction battery acceptance charge rate. As known in the art, a given request for regenerative braking (a negative torque request) will correspond to a rate of power generation. Thus, requests for higher levels of negative torque will correspond to higher rates of power generation. The traction battery 12 may have a limit as to the rate at which it can accept power for storage as mentioned above. This limit may vary depending on battery size, temperature, state of charge (as derived from voltage values), etc.: Decreasing temperatures may reduce the limit, and decreasing states of charge may increase the limit. Temperature of the inverter 14 may also limit the rate at which DC power can be generated and transferred to the traction battery 16. The controller(s) 20 may use known techniques to set and/or adjust the limit value based on temperature, state of charge, etc. If no, the controller(s) 20 use conventional regenerative braking operating strategies at operation 28 to provide the requested negative torque. The algorithm then returns to operation 22.

If yes, at operation 30, the controller(s) 20 determine whether existing energy dissipation methods are able to reduce the regenerative charge rate to be within the capability of the traction battery 12. Electric air conditioners or electric heaters, for example, may be operated with energy generated from regenerative braking activities if conditions are appropriate for such operation (e.g., ambient conditions are ripe for activation of such components, such components are already operating, etc.) If yes, the controller(s) 20 use existing energy dissipation methods to reduce the traction battery charge rate at operation 32. The algorithm then returns to operation 22.

If no, at operation 34, the controller(s) 20 determine whether running the inverter 14 and electric machine 16 in high loss operation mode will reduce the traction battery charge rate to within the limit. The controller(s) 20 may calculate, using standard techniques, the rates at which power will be generated for various switching schemes of the inverter 14. The rates, however, may all still be greater than the limit. The battery, for example, may be cold—resulting in a lowered limit. If no, the controller(s) 20 actuate the friction brakes to satisfy the request for negative torque at operation 36. The algorithm then returns to operation 22.

If yes, at operation 38, the controller(s) 20 determine whether the inverter 14 and electric motor 16 are too hot to operate in high loss mode. The controller(s) 20 may use the temperature data from the sensors 18 to check whether temperatures of the inverter 14 and electric motor 16 are greater than respective thresholds, which may be set using conventional techniques. If yes, the algorithm returns to operation 36. If no, the controller(s) 20 operate the inverter 14 in high loss mode to reduce the traction battery charge rate to within limits of the system at operation 40. The algorithm then returns to operation 22.

The above strategies may allow for less frequent application of friction brakes and more capable energy dissipation/regenerative braking. It may also be used in conjunction with grade assist features in combination with compression braking to slow down the vehicle 10.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. The words used in the specification are words of description rather than limitation, and it is understood that various changes may be made without departing from the spirit and scope of the disclosure.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. An automotive vehicle comprising:
an energy storage arrangement;
an electric machine;
an inverter electrically between the energy storage arrangement and electric machine; and
a controller programmed to, for a given operating point of the electric machine, and
responsive to a negative wheel torque request that corresponds to a charging rate of the energy storage arrangement that exceeds a rate threshold, operate switches of the inverter according to a first method of commutation, and
responsive to a negative wheel torque request that corresponds to a charging rate of the energy storage arrangement that does not exceed the rate threshold, operate the switches according to a second method of commutation.

2. The automotive vehicle of claim 1, wherein the controller is further programmed to, for the given operating point and responsive to the negative wheel torque request that corresponds to the charging rate of the energy storage arrangement that does not exceed the rate threshold and a state of charge of the energy storage arrangement that is greater than a state of charge threshold, operate the switches according to the first method of commutation.

3. The automotive vehicle of claim 2, wherein the controller is further programmed to, for the given operating point and responsive to the negative wheel torque request that corresponds to the charging rate of the energy storage arrangement that does not exceed the rate threshold and a state of charge of the energy storage arrangement that is less than a state of charge threshold, operate the switches according to the second method of commutation.

4. The automotive vehicle of claim 1, wherein the controller is further programmed to, for the given operating point and responsive to the negative wheel torque request that corresponds to the charging rate of the energy storage arrangement that exceeds the rate threshold and a temperature of the electric machine or inverter being greater than a temperature threshold, operate the switches according to the second method of commutation.

5. The automotive vehicle of claim 1, wherein the first method of commutation defines a first switching frequency and the second method of commutation defines a second switching frequency less than the first switching frequency.

6. The automotive vehicle of claim 1, wherein the first method of commutation is state vector pulse width modulation and the second commutation method is six step pulse width modulation.

7. A method comprising:
for a given operating point of an electric machine, and a traction battery state of charge being greater than a state of charge threshold, operating switches of the inverter according to a first method of commutation responsive to a negative wheel torque request; and
for the given operating point, and the traction battery state of charge being less than the state of charge threshold, operating the switches according to a second method of commutation responsive to the negative wheel torque request.

8. The method of claim 7 further comprising, for the given operating point, and the traction battery state of charge being less than the state of charge threshold, operating the switches according to the first method of commutation responsive to the negative wheel torque request corresponding to a charging rate that exceeds a rate threshold.

9. The method of claim 7 further comprising, for the given operating point, the traction battery state of charge being greater than the state of charge threshold, and a temperature of the electric machine or inverter exceeding a temperature threshold, operating the switches according to the second method of commutation.

10. The method of claim 7, wherein the first method of commutation defines a first switching frequency and the second method of commutation defines a second switching frequency less than the first switching frequency.

11. The method of claim 7, wherein the first method of commutation is state vector pulse width modulation and the second commutation method is six step pulse width modulation.

12. A drivetrain comprising:
an electric machine;
an inverter; and
a controller programmed to,
for a given operating point of the electric machine and a negative wheel torque request while a temperature of the electric machine or inverter is less than a temperature threshold, operate the inverter to inject direct axis current into the electric machine, and
for the given operating point and the negative wheel torque request, and the temperature exceeding the temperature threshold, operate the inverter to increase the direct axis current injected into the electric machine.

13. The drivetrain of claim 12, wherein the controller is further programmed to, for the given operating point and the negative wheel torque request while the temperature is less than the temperature threshold, operate the inverter to increase the direct axis current injected into the electric machine responsive to a battery state of charge exceeding a state of charge threshold.

14. The drivetrain of claim 12, wherein the controller is further programmed to, for the given operating point and the negative wheel torque request while the temperature is less than the temperature threshold, operate switches of the inverter according to a first method of commutation.

15. The drivetrain of claim 14, wherein the controller is further programmed to, for the given operating point and the negative wheel torque request while the temperature is greater than the temperature threshold, operate the switches according to a second method of commutation.

16. The drivetrain of claim 15, wherein the first method of commutation defines a first switching frequency and the second method of commutation defines a second switching frequency less than the first switching frequency.
